(19) United States
(12) Patent Application Publication
(10) Pub. No.: US 2010/0013631 A1
(43) Pub. Date: Jan. 21, 2010

(54) ALARM RECOGNITION

(75) Inventors: Peter LAACKMANN, Munich (DE); Marcus JANKE, Munich (DE)

Correspondence Address: DICKSTEIN SHAPIRO LLP, 1633 Broadway, NEW YORK, NY, 10019, US

(73) Assignee: INFINEON TECHNOLOGIES AG, Neubiberg (DE)

(21) Appl. No.: 12/174,186

(22) Filed: Jul. 16, 2008

(51) Int. Cl. G08B 21/00; G08B 17/00

(52) U.S. Cl. 340/540; 340/657; 340/660; 340/658; 340/584

(57) ABSTRACT

A method and apparatus of recognizing an alarm scenario in a chip card. The method includes detecting a deviation of a property, and determining whether the deviation is a result of an alarm scenario.

### FIELD OF THE INVENTION

The present invention relates generally to alarm recognition, and more specifically to distinguishing between an alarm scenario and a non-alarm scenario in smart cards.

### BACKGROUND OF THE INVENTION

A smart card, also known as a chip card or integrated circuit card (ICC), is typically a plastic card about the size of a credit card, with an embedded chip that can be loaded with data, used for telephone calling, electronic cash payments, and other applications.

Smart cards fall into at least two categories: contact and contactless.

Contact smart cards have an interface pad embedded on the surface of the card. The interface pad makes a direct connection with the reader for transfer of data when the card is inserted into a slot of the reader. The reader operates as a communications medium between the contact smart card and a host, for example a computer, a point of sale terminal, or a mobile telephone. The communication between the reader and the contact smart card may be defined for example by ISO (International Organization for Standardization) 7816.

Contactless smart cards communicate without physical insertion of the card into a reader and only require close proximity to a reader, usually within a few inches, to achieve data transmission. The contactless reader, also known as a PCD, includes an antenna electrically coupled to an electronic circuit. The contactless card, also known as a tag, a PICC, or an RFID card, has an inductive antenna and an integrated circuit electrically coupled to the inductive antenna. When the contactless card penetrates a transmission field of the reader, the reader antenna transmits to the contactless card a carrier signal, which generates a radio frequency (RF) field to supply the contactless card with power, and data, which is achieved by amplitude modulation of the carrier signal. In return, the contactless card transmits data by load modulating the carrier signal. This load modulated signal is detected by the reader antenna. The communication between the reader and the contactless card may be defined for example by ISO 14443.

Smart cards have security features for defeating attacks. The goal of such attacks is often to obtain unauthorized access privileges, such as unauthorized disclosure of information, unauthorized modification of information, or unauthorized use of service.

Attacks on smart cards are usually implemented using voltage, clock frequency, electromagnetic radiation, temperature, etc. Attacks are detected when a deviation in a property arises, such as an interruption in an external supply voltage. Smart cards may respond to an attack by storing an alarm status value or flag in a non-volatile manner. Since the external supply voltage is interrupted, residual energy in an energy storage, such as a capacitor, is used to store the value. The alarm status value is stored during a “powerless state,” that occurs directly after interruption of the external voltage supply, and thus the storage process may be referred to as “powerless event storage” (PES) or alternatively a “powerless state storage” (PSS). Since the alarm status value is stored in a non-volatile manner, it is available after a future restart. The alarm status value may, for example, be used to delay subsequent restart of the smart card or to render unusable, after a predetermined number of alarm states, the smart card's processor chip to which the non-volatile memory cell is coupled.

No distinction is made between an alarm scenario and a non-alarm scenario, such as a turn-off scenario. This distinction is important if a reaction to an alarm scenario is to be implemented. When a user prematurely removes a smart card from the reader, there is an unforeseeable turn-off scenario. The turn-off scenario causes an interruption in external supply voltage. Consequently, in the case of poor differentiation, the smart card misinterprets the turn-off scenario as an attempted attack. The result is the smart card responds to the turn-off scenario as if there were an alarm scenario by performing a security function, such as deactivating itself or erasing its memory.

### BRIEF DESCRIPTION OF THE DRAWINGS

FIG. 1A illustrates a system having a smart card and reader;

FIG. 1B illustrates a functional diagram of a chip of the smart card of FIG. 1A; and

FIG. 2 illustrates a method of distinguishing between an alarm scenario and a non-alarm scenario.

### DETAILED DESCRIPTION OF PREFERRED EMBODIMENTS OF THE INVENTION

By way of overview, the present invention is directed to distinguishing between an alarm scenario and a non-alarm scenario in a smart card. An alarm should be triggered only in an event of an attempted attack on the smart card. The distinction is made by detecting a deviation of a property, and then determining whether the deviation is a result of an alarm scenario. The determination can be made, for example, by detecting whether or not the deviation of the property remains, in which case it is determined that there is a non-alarm scenario, or subsides, in which case it is determined that there is an alarm scenario. Alternatively, the determination can be made by detecting a transient of the deviation, and determining whether or not there is an alarm scenario based on a characteristic of the transient.

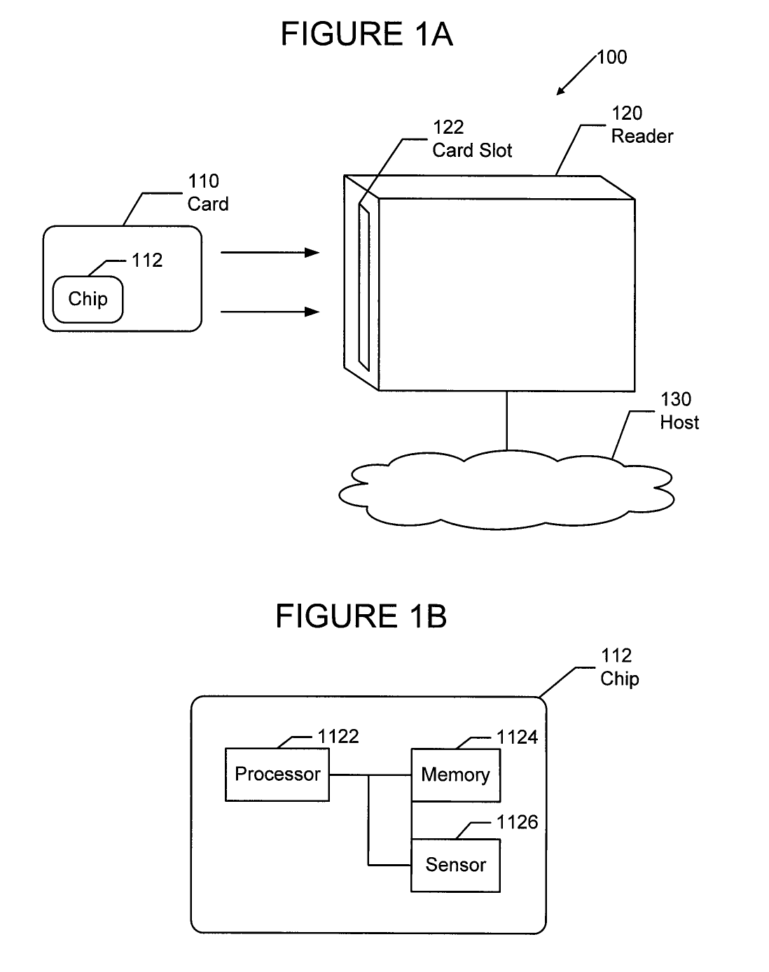

FIG. 1A illustrates a system 100 having smart card 110, reader 120, and host 130. Reader 120 operates as a communications medium between smart card 110 and host 130, which may be for example a computer, a point of sale terminal, or a mobile telephone. Smart card 110 includes processor chip 112.

When card 110 is inserted in card slot 122 of reader 120, an interface pad (not shown) embedded on the surface of card 110 makes direct connect with reader 120 for transfer of data between reader 120 and smart card 110. System 100 is illustrated as being contact-based, but may alternatively be contactless, as described above.

FIG. 1B illustrates a functional diagram of chip 112 shown in FIG. 1A. Chip 112 has processor 1122 configured to process information, memory 1124 configured to store data, and sensor 1126 configured to sense one or more environmental conditions or properties.

FIGS. 1A and 1B show smart card 110 with processor chip 112. In an alternative embodiment, smart card 110 may instead be a memory card, a security counter card, a data carrier card, etc. These types of cards do not have a processor, but instead have a state-machine which controls behavior of a chip within the card.

Attacks on smart cards 110 are typically performed using voltage, clock frequency, electromagnetic radiation, temperature, etc., as is known. For example, data and passwords stored in memory 1124 of smart card 110 can be erased or modified in response to an unusual supply voltage. Other attack methods include heating chip 112 to a high temperature, cooling chip 112 to a low temperature, or focusing UV light on memory 1124, thereby removing a security lock. Smart cards 110 generally implement security using sensors 1126 configured to detect any deviations in one or more of these properties. However, a deviation in a property does not necessarily mean that an attack on smart card 110, that is an alarm scenario, is occurring. The present invention is advantageous in that it can distinguish between an alarm scenario and a non-alarm scenario.

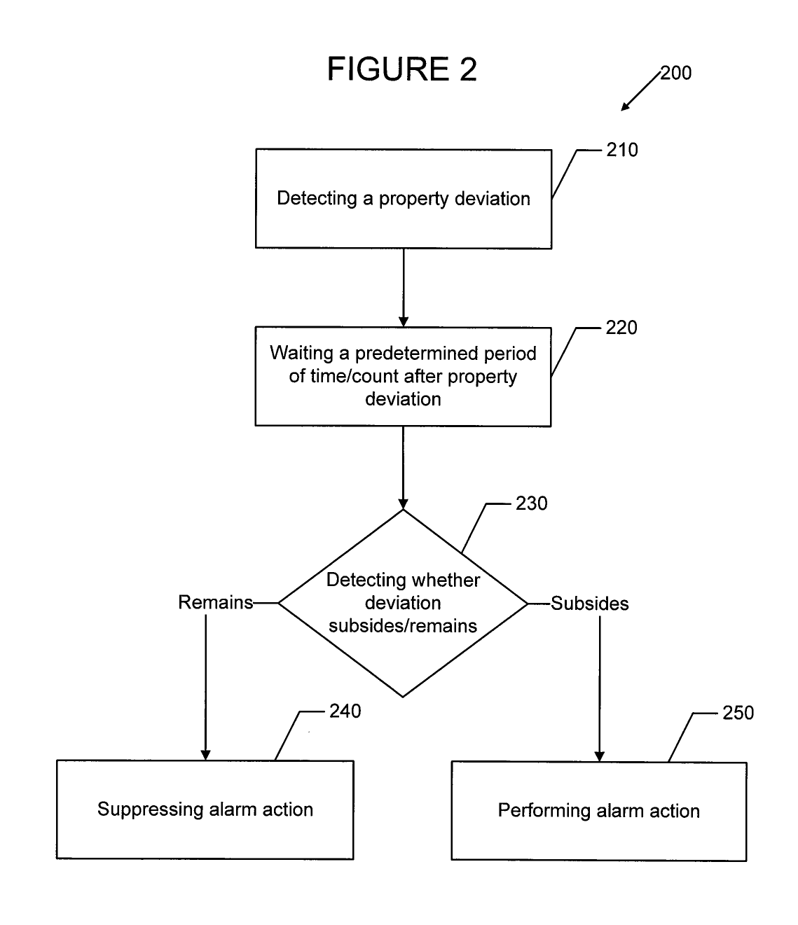

FIG. 2 illustrates a method for distinguishing between an alarm scenario and a non-alarm scenario in smart card 110. By way of overview, the distinction between alarm and non-alarm scenarios is performed by first detecting a deviation of a property (step 210). It is then determined whether the deviation of the property remains or subsides (step 230) at a particular time after the detected deviation (step 220). If the deviation remains, it is determined that a non-alarm scenario is occurring, and any alarm action is suppressed (step 240). On the other hand, if the deviation subsides, it is determined that an attack on the smart card is occurring, and any appropriate alarm action can be performed (step 250).

More detailed explanations of the invention with respect to some of the potentially monitored properties, that is voltage, clock frequency, electromagnetic radiation, temperature, etc., follows.

If the property to be monitored is an external supply voltage, sensor 1126 includes an external voltage sensor and a comparator and is configured to detect when the external supply voltage goes below a predetermined lower limit. The voltage sensor senses the external supply voltage, and then comparator compares the sensed voltage with the predetermined lower limit. If sensor 1126 detects a deviation or drop in the external supply voltage below the lower limit (step 210), processor 1122 determines whether this drop in external supply voltage is due to an alarm scenario or alternatively due to a non-alarm scenario, such as a turn-off. The alarm scenario is a result of an attempted attack on smart card 110. A turn-off scenario, on the other hand, could result from a user prematurely withdrawing contact smart card 110 from contact reader 120, or the user prematurely moving a contactless smart card out of range of a contactless reader.

In order to make a distinction between a non-alarm scenario and an alarm scenario, processor 1122 determines whether the deviation in external supply voltage remains, that is stays below the lower limit, or whether the deviation subsides, that is the external supply voltage returns to a level that is above the lower limit (step 230).

If the deviation subsides, that is the external supply voltage returns to being above the lower limit, then processor 1122 determines that smart card 110 was not intended to be turned off and the voltage drop must have been attributable to an attempted attack on smart card 110; processor 1122 can therefore perform an alarm action (step 250). The alarm action could be a powerless event storage, as described above.

Alternatively, if the deviation in external supply voltage remains below the lower limit, processor 1122 determines that no attack on smart card 110 is occurring, but instead there is a non-alarm scenario, such as a turn-off scenario. The alarm is therefore rated as a false alarm, and processor 1122 suppresses any alarm action (step 240).

A certain period of time should pass before processor 1122 determines whether the drop in the external supply voltage below the lower limit remains or subsides (step 220). One option is to wait until just before a powerless event storage occurs. More specifically, following the detection of the drop in external supply voltage below the lower limit, processor 1122 prepares to store the alarm status value during a powerless event storage. However, just before the alarm status value is actually stored, processor 1122 determines whether the drop in the external supply voltage remains or subsides below the lower limit (step 230), and then continues with the method as described above. Alternatively, a counter or timer can be used to determine a predetermined time for processor 1122 to determine whether the deviation in the external supply voltage remains or subsides.

An upper limit, as opposed to a lower limit, of the external supply voltage of smart card 110 can additionally or alternatively be used to distinguish between an alarm scenario and a non-alarm scenario. In such a case, sensor 1126 may include a voltage sensor and a comparator configured to detect a deviation in external supply voltage above an upper limit (step 210). The voltage sensor senses the external supply voltage, and then comparator compares the sensed voltage with the predetermined upper limit. After a predetermined period of time (step 220) processor 1122 determines whether the external supply voltage remains above the upper limit (step 230). If so, processor 1122 determines that there is a non-alarm scenario occurring, and any alarm action is suppressed (step 24). Otherwise, processor 1122 determines that an attack on smart card 110 is occurring, and any appropriate alarm action is performed (step 250).

In the case of a contactless smart card, the external power supply transient can be monitored to distinguish between an alarm scenario and a non-alarm scenario. Some contactless smart cards obtain their external supply voltage from the carrier signal of a contactless reader. When the contactless smart card leaves a magnetic field of the contactless reader, sensor 1126 detects a smooth transition between the external power supply being available and then not available, that is the external power supply gradually decreases in intensity in an analog-type fashion. Similarly, when the contactless smart card moves back into the magnetic field of the contactless reader, sensor 1126 detects the external power supply gradually becoming stronger in terms of energy. In contrast, when a contact smart card is removed from or inserted into reader 120, sensor 1126 detects the external supply voltage dropping suddenly or increasing suddenly in more of a digital-type fashion. During an attack scenario on the other hand, the external supply voltage is increased and decreased suddenly, whether smart card 110 is contact or contactless. Therefore in the case of a contactless supply voltage, processor 112 interprets a gradual transition of the external supply voltage as a non-alarm scenario. Sensor 1126 may be configured to detect the external power supply transition in any known manner.

A transient of the external supply voltage of either a contact or contactless smart card 110 may alternatively or additionally be used by processor 1122 to distinguish between an alarm scenario and a non-alarm scenario. A turn-off scenario generally involves the external supply voltage dropping below a lower limit a single time for a significant period of time, in which case a large amount of energy will be lost. On the other hand, an alarm scenario may involve the external supply voltage increasing above an upper limit and/or decreasing below a lower limit once briefly or more than a predetermined number of times during a predetermined period of time, in which case a relatively small amount of energy will be lost. Therefore, if sensor 1126 detects the external supply voltage crossing the limits in this latter manner, processor 1122 will determine that there is an attack being made on the smart card 110, and an alarm scenario is occurring.

An internal voltage, as opposed to an external supply voltage, of smart card 110 may alternatively or additionally be used to distinguish between an alarm scenario and a non-alarm scenario. In such a case, sensor 1126 includes an internal voltage sensor and comparator configured to detect when the internal voltage drops below a lower limit and/or goes above an upper limit. Again, processor 1122 interprets any sudden deviation in the internal voltage, either above the upper limit or below the lower limit, that remains as a non-alarm scenario, and interprets any sudden deviation that subsides as an alarm scenario. The method of distinguishing between an alarm and non-alarm scenario in a smart card 110 using internal voltage is similar to that described above with respect to external supply voltage. For the sake of brevity, a more detailed description of the invention with respect to internal voltage will therefore be omitted here.

Clock frequency, internal and/or external, of smart card 110 may alternatively or additionally be used to distinguish between an alarm scenario and a non-alarm scenario. In such a case sensor 1126 includes a frequency detector and comparator configured to detect when internal and/or external clock frequency goes above a high limit and/or below a low limit. The method of distinguishing between an alarm and non-alarm scenario in a smart card 110 using internal and/or external clock frequency is similar to that described above with respect to external supply voltage. For the sake of brevity, a more detailed description of the invention with respect to clock frequency will therefore be omitted here.

Temperature of smart card 110 may alternatively or additionally be used to distinguish between an alarm scenario and a non-alarm scenario. In such a case sensor 1126 includes a temperature sensor and comparator configured to detect when the temperature of chip 110 goes above a high limit and/or below a low limit. The method of distinguishing between an alarm and non-alarm scenario in a smart card 110 using temperature is similar to the method described above with respect to external supply voltage. For the sake of brevity, a more detailed description of the invention with respect to temperature will therefore be omitted here.

Similarly, electromagnetic radiation, such as light, shining on smart card 110 may alternatively or additionally be used to distinguish between an alarm scenario and a non-alarm scenario. In such a case sensor 1126 includes an optical sensor and comparator configured to detect when electromagnetic radiation shining on smart card 110 goes above an upper limit and/or below a lower limit. The method of distinguishing between an alarm and non-alarm scenario in a smart card 110 using electromagnetic radiation is similar to the method described above with respect to external supply voltage. For the sake of brevity, a more detailed description of the invention with respect to electromagnetic radiation will therefore be omitted here.

It will be appreciated that the invention is not limited to monitoring a deviation of a single property to distinguish between an alarm scenario and a non-alarm scenario. Any combination of properties may be monitored for deviation. Further, a transient of any of the properties may be monitored.

Specific values of upper and lower limits of monitored properties have not been provided. The values of the upper and lower limits may be any values suitable for the intended purpose.

The invention has been described as being implemented in hardware. Of course the invention is not intended to be limited to the specific hardware described, but may alternatively be implemented in any equivalent hardware suitable for the intended purpose. Also, as is known to those of skill in the art, the invention may alternatively be implemented in software.

While at least one exemplary embodiment has been presented in the foregoing detailed description, it should be appreciated that variations exist. It should also be appreciated that the exemplary embodiment or exemplary embodiments are only examples, and are not intended to limit the scope, applicability, or configuration of the invention in any way. One skilled in the art will appreciate that additional variations may be made in the above-described embodiment of the present invention without departing from the spirit and scope of the invention.

1. A method of recognizing an alarm scenario in a chip card, the method comprising:
detecting a deviation of a property; and
determining whether the deviation is a result of an alarm scenario.

2. The method of claim 1, wherein the determining comprises:
detecting whether the deviation subsides; and
performing an alarm action if the deviation subsides.

3. The method of claim 2, wherein the alarm action is a powerless event storage.

4. The method of claim 1, wherein the determining comprises:
detecting whether the deviation remains; and
suppressing an alarm action if the deviation remains.

5. The method of claim 4, wherein the alarm action is a powerless event storage.

6. The method of claim 1, wherein the property is voltage.

7. The method of claim 1, wherein the property is frequency.

8. The method of claim 1, wherein the property is electromagnetic radiation.

9. The method of claim 1, wherein the property is temperature.

10. The method of claim 2, wherein the determining occurs after at least one of a predetermined period of time and a predetermined number of counts of a counter.

11. The method of claim 1, wherein the detecting a deviation of a property comprises detecting a transient of the property, and the determining whether the deviation is a result of an alarm scenario is based on a characteristic of the transient.

12. The method of claim 1, wherein the determining occurs just prior to when a powerless event storage operation would occur if there were an alarm scenario.

13. A chip card comprising:
a deviation detector configured to detect a deviation of a property; and
an alarm scenario detector configured to determine whether the deviation of the property is a result of an alarm scenario.

14. The chip card of claim 13, wherein the alarm scenario detector is configured to detect whether the deviation subsides, thereby indicating an alarm scenario.

15. The chip card of claim 13, wherein the alarm scenario detector is configured to detect whether the deviation remains, thereby indicating a non-alarm scenario.

16. The chip card of claim 13, wherein the property is voltage, and the alarm scenario detector comprises:
a voltage detector configured to detect the voltage; and
a comparator configured to compare the detected voltage with a predetermined value.

17. The chip card of claim 13, wherein the property is frequency, and the alarm scenario detector comprises:
a frequency detector configured to detect the frequency; and
a comparator configured to compare the detected frequency with a predetermined value.

18. The chip card of claim 13, wherein the property is electromagnetic radiation, and the alarm scenario detector comprises:
an electromagnetic radiation detector configured to detect the electromagnetic radiation; and
a comparator configured to compare the detected electromagnetic radiation with a predetermined value.

19. The chip card of claim 13, wherein the property is temperature, and the alarm scenario detector comprises:
a temperature detector configured to detect the temperature; and
a comparator configured to compare the detected temperature with a predetermined value.

20. The chip card of claim 14, wherein the alarm scenario detector is configured to detect whether the deviation subsides after at least one of a predetermined period of time and a predetermined number of counts of a counter.

21. The chip card of claim 13, wherein the deviation detector is configured to detect a transient of the property, and the alarm scenario detector is configured to determine whether the deviation is a result of an alarm scenario based on a characteristic of the transient.

22. The chip card of claim 13, wherein the alarm scenario detector is configured to make the determination just prior to when a powerless event storage operation would occur if there were an alarm scenario.

23. The chip card of claim 13, further comprising a memory configured to store data related to the alarm scenario.

24. A chip card comprising:
a deviation detecting means for detecting a deviation of a property; and
an alarm scenario detecting means for determining whether the deviation of the property is a result of an alarm scenario.

25. A system comprising:
a chip card comprising:
a deviation detector configured to detect a deviation of a property; and
an alarm scenario detector configured to determine whether the deviation of the property is a result of an alarm scenario; and
a reader configured to communicate with the chip card.
